(19) United States
(12) Patent Application Publication
(10) Pub. No.: US 2006/0042217 A1
(43) Pub. Date: Mar. 2, 2006

(54) Front attachment for a harvesting machine

(76) Inventor: Dominik Buermann, Verl (DE)

Correspondence Address: STRIKER, STRIKER & STENBY, 103 EAST NECK ROAD, HUNTINGTON, NY, 11743, US

(21) Appl. No.: 11/214,961

(22) Filed: Aug. 30, 2005

(30) Foreign Application Priority Data
Aug. 31, 2004 (DE) 10 2004 042 437.3

(51) Int. Cl. A01D 34/30

(52) U.S. Cl. 56/257

(57) ABSTRACT

A front attachment for a self-propelled harvesting machine has at least one working member, and a cutting table with at least two cutter bar sections each driven by at least one cutting knife train, at least one working member couples the cutting knife drive trains with each other.

### BACKGROUND OF THE INVENTION

The present invention relates to a front attachment for a self-propelled harvesting machine, preferably a combine harvester.

A front attachment for a harvesting machine is disclosed in U.S. Pat. No. 3,577,716, with which the two cutter bar sections are driven independently, each by a drive train, each drive train being coupled individually to a drive unit located on the harvesting machine. The rotary motion of the drive unit is converted in the knife gear systems of the knife drive trains into an oscillatory motion to drive the cutter bar sections in a reciprocating manner. The two cutter bar sections extend across nearly half of the cutter bar and move in opposite directions relative to each other.

The disadvantage of this known front attachment is that, when the two drive trains are attached to the drive unit of the combine harvester, the position of the cutter bar sections relative to each other must be checked and may need to be adjusted to ensure that the cutter bar sections move in a reciprocating manner in opposite directions relative to each other, since this is the only way to dampen the oscillations of the front attachment caused by the moving direction—in accordance with the mass balance—of the cutter bar sections and the symmetrical mass distribution.

### SUMMARY OF THE INVENTION

The present invention is therefore based on the object of providing a front attachment that avoids the disadvantages of the related art, and with which the coordinated motion of the cutter bar sections relative to each other is permanently fixed.

In keeping with these objects and with others which will become apparent hereinafter, one feature of the present invention resides, briefly stated, in a front attachment for a self-propelled harvesting machine, comprising at least one working member; and a cutting table with at least two cutter bar sections each driven by at least one cutting knife train, wherein said at least one working member couples said cutting knife drive trains with each other.

Due to the fact that the cutting knife drive trains are advantageously coupled with each other via at least one working member of the front attachment, the cutting knife drive trains remain interconnected even when the front attachment is removed, thereby ensuring that the coordinated motion of two cutter bar sections is permanently fixed.

In an advantageous embodiment of the front attachment according to the present invention, the working member is designed as an auger with which the crop material is conveyed to the incline conveyor and is thereby compressed to the width of the inlet opening of the incline conveyor. The cutting knife drive trains are coupled via a working device which is already present on the front attachment.

In a further advantageous embodiment of the front attachment according to the present invention, the cutting table has two adjacently positioned cutter bar sections that each extend over one half of the width of the cutting mechanism and move in opposite directions relative to each other, so that the forces caused by the reciprocal motion of the cutter bar sections cancel each other out.

In an alternative embodiment of the front attachment according to the present invention, the auger is driven by a hydraulic motor. The combine harvester is therefore connected with the front attachment only via hydraulic lines.

Due to the fact that the drive energy for the cutting knife drive trains is derived from the auger, no additional drives are required for the cutting knife drive trains, and the two cutting knife drive trains are driven in a synchronous manner.

Advantageously, the auger serves as a centrifugal mass for the cutter bar sections, so that the cutter bar sections continue to move in an even manner even when a higher cutting output is briefly required of the cutter bar sections. Due to its high inertial mass, the rotating auger is the energy accumulator for the cutter bar sections.

Due to the fact that the auger interconnects the cutting knife drive trains in a form-fit manner, the cutter bar sections are driven without slippage, and it is nearly impossible for the motion of the cutter bar sections in opposite directions relative to each other to be thrown out of synchronization.

In a particularly advantageous embodiment of the front attachment according to the present invention, the cutting knife drive train has an angle gear with a driven shaft end and a spur gear mounted non-rotatably on the driven shaft end, so that the redirection of the rotary motion and the transmission ratios are enabled using cost-effective, readily available standard components.

In an advantageous further development of the present invention, the angle gears and the spur gear are rigidly supported on a console, which itself is rigidly connected with the cutting table, so that the position of the gears relative to each other and the cutting table and, in particular, the position of the cardan shaft connected with the driven shaft end of the flat gear are fixed.

The novel features which are considered as characteristic for the present invention are set forth in particular in the appended claims. the invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 is a part of a top view of a schematically depicted combine harvester with the front attachment according to the present invention.

### DESCRIPTION OF THE PREFERRED EMBODIMENTS

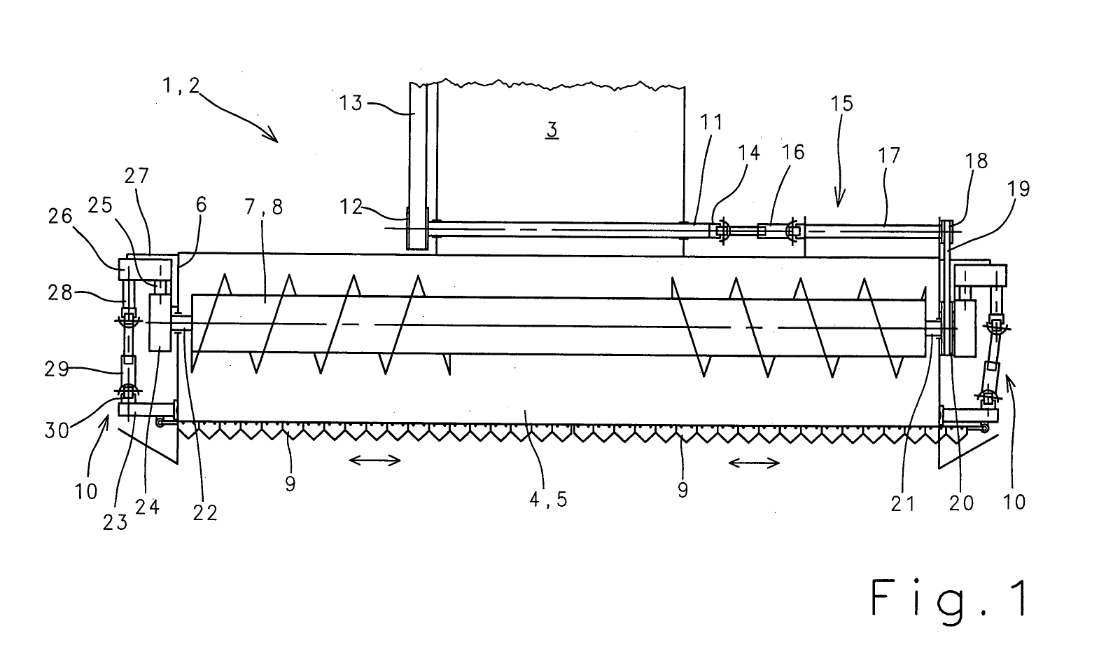

FIG. 1 shows a portion of the schematic top view of an agricultural harvesting machine 2 designed as a self-propelled combine harvester 1, on the inclined conveyor 3 of which a front attachment 5 designed as a cutting mechanism 4 is located. Cutting mechanism 4 is composed substantially of a cutting table 6 and a working member 8 designed as a rotatably driven auger 7.

The crop material is cut by two cutter bar sections 8 located in the front region of cutting table 6 and subsequently conveyed to auger 7, which conveys the crop material to inclined conveyor 3. Adjacently positioned cutter bar sections 9 each extend across nearly one half of cutting mechanism 4 and are driven independently, in an oscillating manner, via a cutting knife drive train 10. It is within the scope of the present invention for cutter bar sections 9 to be located one on top of the other and for both cutter bar sections 9 to extend across the entire width of cutting table 4, so that, as a pair, they form a “double blade”.

A drive shaft 11 with a drive wheel 12 is located on inclined conveyor 3, the drive shaft being driven via a traction mechanism 13 by the main drive (not shown) of harvesting machine 2. Drive shaft 11 is detachably connected via a coupling 14 with a drive train 15 to drive the individual assemblies of cutting mechanism 4, which is composed of a cardan shaft 16 and an input shaft 17 connected therewith at one end, whereby input shaft 17 is supported at cutting table 6 at a distance from the axis of rotation of auger 7. A sprocket wheel 18 is non-rotatably mounted on the free end of input shaft 17, the sprocket wheel being connected via a chain 19 with a further sprocket wheel 20 which is non-rotatably mounted on a first shaft end 21 of auger 7 located on the front side of auger, and via which auger 7 is rotatably driven. It is within the framework of the present invention that, in an alternative embodiment, auger 7 can be driven via a hydraulic motor, which is mounted, e.g., on first shaft end 21 of auger 7.

On the side of cutting mechanism 4 diametrically opposed to drive train 15, a further shaft end 22 is located on the front side of auger 7, the shaft end—and first shaft end 21—being non-rotatably connected with auger 7. Each of the shaft ends 21, 22 of auger 7 is connected with the cutting knife drive train 10—enabling each to drive a cutter bar section 9—in such a manner that the drive energy for cutter bar sections 9 is derived from auger 7, and cutting knife drive trains 10 are coupled with each other in a form-fit manner via auger 7 and without slippage, according to the present invention. Simultaneously, auger 7 serves as a centrifugal mass for cutter bar sections 9 which, due to their inertia, move cutter bar sections 9 in a uniform manner, even when a higher cutting output is briefly required of cutter bar sections 9.

Cutting knife drive trains 10 are designed as mirror images of each other, each one being composed of an angle gear 24 mounted non-rotatably on associated shaft end 21, 22, a spur gear 26 being non-rotatably slid onto driven shaft end 25 of angle gear 24. Spur gear 26 and angle gear 24 are rigidly supported on a console 27, which itself is rigidly connected with cutting table 6. A second driven shaft end 28 is located at spur gear 26 on the side facing angle gear 24, the second driven shaft end being interconnected with drive shaft 30 of a cutter bar section gear 23 via a cardan shaft 29, the cutter bar section gear converting the rotary motion of cardan shaft 29 to a translatory motion in a manner known per se and driving associated cutter bar section 9 in an oscillating manner.

The drive energy of auger 7 is transferred via cutting knife drive trains 10 in a form-fit manner to cutter bar sections 9, thereby ensuring that the motions of the cutter bar sections—which are opposed relative to each other—remain synchronous.

It is within the scope of the ability of one skilled in the art to modify the exemplary embodiments described in a manner not presented, or to use it in other machines to achieve the effects described, without leaving the framework of the invention.

It will be understood that each of the elements described above, or two or more together, may also find a useful application in other types of constructions differing from the types described above.

While the invention has been illustrated and described as embodied in a front attachment for a harvesting machine, it is not intended to be limited to the details shown, since various modifications and structural changes may be made without departing in any way from the spirit of the present invention.

Without further analysis, the foregoing will reveal fully revela the gist of the present invention that others can, by applying current knowledge, readily adapt it for various applications without omitting features that, from the standpoint of prior art, fairly constitute essential characteristics of the generic or specific aspects of the invention.

What is claimed as new and desired to be protected by Letters Patent is set forth in the appended claims:

1. A front attachment for a self-propelled harvesting machine, comprising at least one working member; and a cutting table with at least two cutter bar sections each driven by at least one cutting knife train, wherein said at least one working member couples said cutting knife drive trains with each other.

2. A front attachment as defined in claim 1, wherein said at least one working member is configured as an anger.

3. A front attachment as defined in claim 1, wherein said two cutter bar sections are positioned adjacently and each extend substantially over one half a width of said cutting table and move in opposite directions relative to each other.

4. A front attachment as defined in claim 2; and further comprising a hydraulic motor which drives said anger.

5. A front attachment as defined in claim 2, wherein said anger and said cutting knife drive trains are arranged so that a drive energy for said cutting knife drive trains is derived from said anger.

6. A front as defined in claim 2, wherein said anger forms a centrifugal mass for said cutter bar sections.

7. A front attachment as defined in claim 2, wherein said anger interconnects said cutting knife drive trains in a form-fit manner.

8. A front attachment as defined in claim 1, wherein said cutting knife drive train has an angle gear with a driven shaft end and a spur gear mounted non-rotatably on said driven shaft end.

9. A front attachment as defined in claim 8; and further comprising a console which is rigidly connected with said cutting table, said angle gear and said spur gear being rigidly supported on said console.
